(19) United States
(12) Patent Application Publication
(10) Pub. No.: US 2026/0192366 A1
(43) Pub. Date: Jul. 9, 2026

(54) Railway Wheel Truing Apparatus

(71) Applicant: Southeast Motive Power, LLC, Loranger, LA (US)

(72) Inventor: Warren J. Brown, Loranger, LA (US)

(73) Assignee: Southeast Motive Power, LLC, Loranger, LA (US)

(21) Appl. No.: 19/441,631

(22) Filed: Jan. 6, 2026

Related U.S. Application Data
(60) Provisional application No. 63/742,613, filed on Jan. 7, 2025.

(51) Int. Cl. B23B 5/32; B23P 6/00

(52) U.S. Cl. CPC B23B 5/32; B23P 6/00; B23P 2700/50

(57) ABSTRACT

A portable railway wheel truing apparatus is disclosed herein. The machine uses multiple cutting tools set along a path corresponding to a target wheel profile for a railway wheel. The tool path is set by the interaction of different guide slots on a guide plate and drive slots on drive plates that slide back and forth across the guide plate. The cutting tools are connected to guide pins that pass through and are able to roll within the guide slots in the guide plate and drive slots in the drive plates. Thus, as the drive plates move, they push the guide pins along a path formed by the overlap of the drive slots in the drive plates and the guide slots in the guide plate.

### CROSS REFERENCE TO RELATED APPLICATION

This application claims the benefit of U.S. Provisional Application Ser. No. 63/742,613, filed Jan. 7, 2025, which is incorporated by reference herein in its entirety.

### BACKGROUND OF THE INVENTION

Railway wheel truing machines are specialized devices used to restore the proper wheel profile of the wheels of railway vehicles by removing irregularities and wear, such as flat spots or other out-of-round conditions. These machines are essential for maintaining railway safety, performance, and longevity of the rail tracks. In fact, the Federal Railroad Administration (FRA) and the Association of American Railroads (AAR) set thresholds for the proper wheel profile of rail wheels. Wheel Profile Detectors (WPDs) measure wheel profiles of moving trains using laser and optical scanning devices to take images of the flange, tread, and other aspects of the wheel. This data can alert railroads when immediate action must be taken to remove a car from service if a wheel is worn beyond the FRA and AAR thresholds.

Railway wheel truing machines use cutting tools to remove material from the surface of the wheel's flange, tread, and/or throat (i.e., the curved area interconnecting the flange and tread), refurbishing the wheel's profile to the standardized shape specified by FRA and AAR regulations. Reshaping wheels using truing machines helps reduce rail wear, increase wheel life, and ensure a smoother, safer ride on railways.

Railway wheel truing machines typically come in one of three forms: an underfloor wheel lathe, a pit wheel lathe, or a portable truing machine. Both underfloor wheel lathes and pit wheel lathes are fixed equipment typically installed at a railway equipment maintenance facility. An underfloor wheel lathe is a specialized machine used for truing (reshaping) railway wheels while they remain mounted on the railway vehicle. This equipment is installed below the rail tracks in maintenance facilities, allowing wheels to be machined without the need to remove the axle or disassemble the vehicle. In contrast, a pit wheel lathe requires the wheels or wheelsets to be removed from the railway vehicle and placed on the lathe for machining. These machines are typically installed in a pit area at a maintenance facility and are designed to handle off-car wheelsets. Both modern underfloor lathes and pit wheel lathes use computer numerical control (CNC) technology for precision cutting that automatically adjusts to specific wheel profiles based on input parameters, while taking dynamic measurements using integrated sensors to measure wheel wear, geometry, and defects before and during the truing process. Pit wheel lathes and underfloor wheel lathes also both utilize two main cutting tool holders: one for the tread and one for the flange, with each tool holder having multiple cutting inserts to increase the speed and efficiency of the truing operation. During truing operations, the cutting tool holders will move both axially (i.e., parallel to the axis of the wheel) and radially (i.e., toward and away from the wheel's surface), with some units also providing for rotational adjustment to adjust the angle of the cutting tool holders. Modern CNC systems dynamically adjusting the position of the tool holders in real time to ensure accurate and consistent cutting of the wheel.

In contrast to underfloor wheel lathes and pit wheel lathes that are fixed systems installed at railway vehicle maintenance facilities, portable truing machines are compact, mobile devices designed for reshaping and restoring the profile of railway wheels on-site (e.g., trackside or at a rail yard). Conventional portable railway wheel truing machines typically use one cutting tool to reshape both the wheel flange and tread, with this singular cutting tool moving back and forth in a path that mimics the wheel profile. Some models are manually operated, while others use motorized systems.

Portable wheel truing machines are a critical tool for addressing in-field maintenance of railway wheels. As noted above, the FRA sets standards for railway wheel conditions, including acceptable limits for wear and defects. If a wheel's profile is determined to be outside of the acceptable FRA threshold, the wheel must be addressed before the locomotive can continue in regular service. At this point, the operator generally has three options: (1) request a special waiver from the FRA to move a non-complying locomotive to another location where it can have the wheel machined or replaced, (2) replace the wheelset in the field, or (3) call a contractor to repair the wheel on-site using a portable wheel truing machine. Because every minute the locomotive cannot run means lost money for the operator, the most cost-effective option typically is to have a contractor repair the wheels on-site using a portable truing machine. However, conventional portable truing machines can take 6-8 hours to refurbish a single wheel. Further, conventional portable truing machines typically are manually operated by the contractor, thereby rendering them less precise than the CNC-controlled underfloor lathes or pit lathes. Thus, there remains a need in the art for an improved portable wheel truing machine that can refurbish railway wheels more accurately and efficiently.

### BRIEF DESCRIPTION OF DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages in accordance with the present invention:

FIG. 1 is a perspective view of an embodiment of a portable railway wheel truing apparatus exemplifying the principles of the present invention installed in place to true a railway wheel;

FIG. 2 is a perspective view of the portable railway wheel truing apparatus shown in FIG. 1;

FIG. 3 is a horizontally exploded view of the portable railway wheel truing apparatus shown in FIG. 1;

FIG. 4 is a vertically exploded view of the portable railway wheel truing apparatus shown in FIG. 1;

FIG. 5 is a top view of the portable railway wheel truing apparatus shown in FIG. 1;

FIG. 6 is a front view of the portable railway wheel truing apparatus shown in FIG. 1;

FIG. 7 is a right-side view of the portable railway wheel truing apparatus shown in FIG. 1;

FIG. 8 is a left-side view of the portable railway wheel truing apparatus shown in FIG. 1;

FIG. 9 is a view of the portable railway wheel truing apparatus shown in FIG. 1 secured to a rail by an exemplary clamping system;

FIG. 10 is a close-up view of the cutting tools of the portable railway wheel truing apparatus shown in FIG. 1 cutting a railway wheel;

FIGS. 11-13 illustrate the movement of the drive plates and guide pins relative to the guide plate during operation of the portable railway wheel truing apparatus shown in FIG. 1; FIG. 11 shows the positioning of the drive plates and guide pins in the First Position; FIG. 12 shows the positioning of the drive plates and guide pins in the Second Position; FIG. 13 shows the positioning of the drive plates and guide pins in the Third Position;

FIGS. 14-16 illustrate the corresponding movements of the cutting tools during operation of the portable railway wheel truing apparatus shown in FIG. 1; FIG. 14 shows the positioning of the cutting tools in the First Position; FIG. 15 shows the positioning of the cutting tools in the Second Position; FIG. 16 shows the positioning of the cutting tools in the Third Position;

FIGS. 17-24 illustrate the geometry of the drive plates of the portable railway wheel truing apparatus shown in FIG. 1; FIG. 17 shows the geometry of the first drive plate, and FIG. 18 is a close-up showing the geometry of the drive slots on the first drive plate; FIG. 19 shows the geometry of the second drive plate, and FIG. 20 is a close-up showing the geometry of the drive slots on the second drive plate; FIG. 21 shows the geometry of the fourth drive plate, and FIG. 22 is a close-up showing the geometry of the drive slots on the fourth drive plate; FIG. 23 shows the geometry of the third drive plate, and FIG. 24 is a close-up showing the geometry of the drive slots on the third drive plate;

FIG. 25 illustrates the geometry of the guide plate of the portable railway wheel truing apparatus shown in FIG. 1;

FIG. 26 is a perspective view of the guide plate shown in FIG. 25;

FIG. 27 shows multiple views of the first tool holder plate of the portable railway wheel truing apparatus shown in FIG. 1; and

FIG. 28 shows multiple views of the second tool holder plate of the portable railway wheel truing apparatus shown in FIG. 1.

### DETAILED DESCRIPTION OF THE INVENTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions. As used herein, a “railway vehicle” is to be understood to include any vehicle designed to operate on railway tracks for the purposes of transporting passengers, goods, or providing propulsion, including locomotives, railcars, passenger cars, and freight cars.

The invention disclosed herein is directed to a portable railway wheel truing machine having two or more cutting tools operating on a pre-set wheel profile. Integrating multiple cutting tools onto the truing machine allows the machine to true a wheel at exponentially faster speeds, depending on the number of tools used. Additionally, the machine is sufficiently compact that two opposing duplicate machines may work in tandem on the same wheel set, one on the right wheel and one on the left wheel, further cutting down on the time the railway vehicle is out of operation.

The tools are moved back and forth along a set wheel profile by pins guided through overlapping slots in drive plates and a guide plate. The geometry of the slots in both the drive plates and guide plate has been configured so that the movement of the drive plates directs the guide pins (and therefore the cutting tools) along a path that corresponds to the standardized profile of a railway wheel. Once the machinist has set the initial angle of the machine, there should be no need for the machinist to make adjustments while the machine trues the wheel. Because the truing apparatus of the present invention does not utilize a computer, it is cheaper to produce and to operate. Additionally, because the machine is able to true a wheel in a fraction of the time traditional portable machines need, it significantly reduces the time a railway car is out of operation, saving money for locomotive operators.

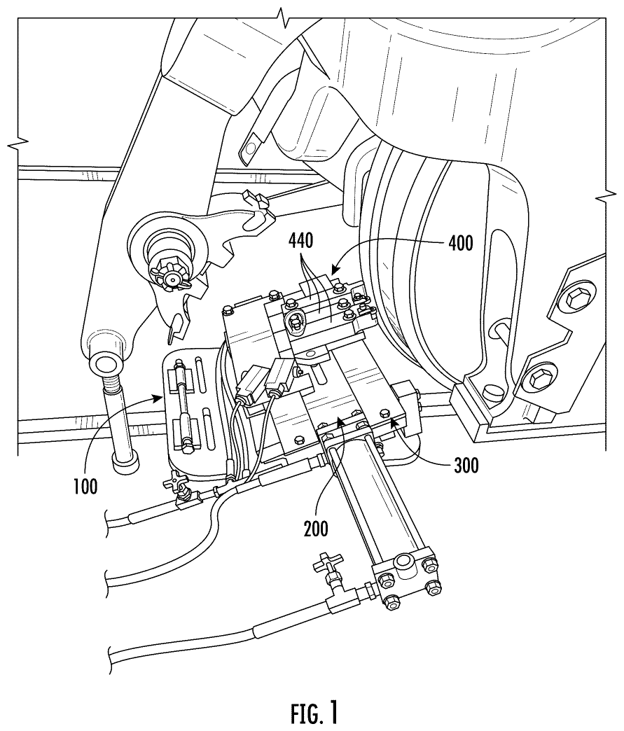

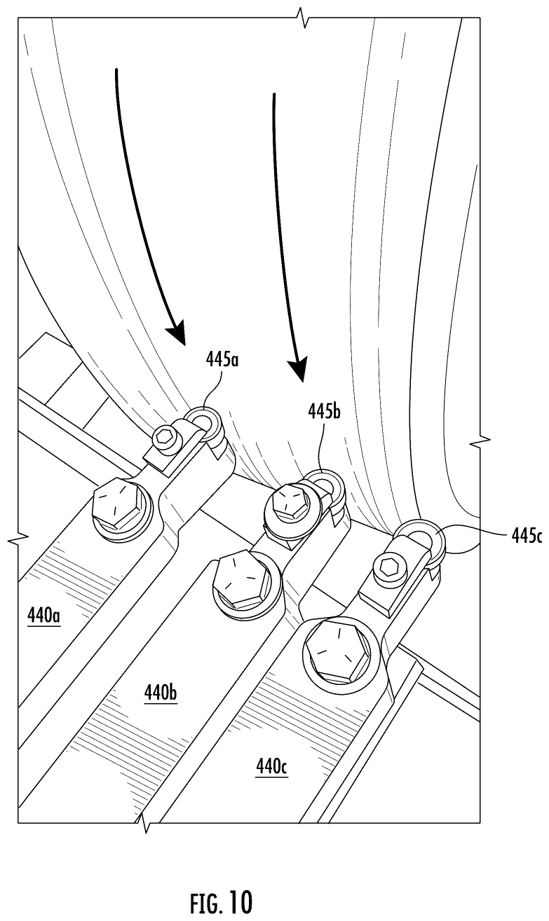

FIG. 1 illustrates the machine 1 installed in position behind a damaged wheel. With the machine properly clamped on the rail, the cutting tools are aligned with the wheel. Once the machine 1 is in position, the wheel is set to spin, and the machine starts moving the cutting tools back and forth horizontally, along the wheel profile. FIG. 10 is a closeup view of this process. To machine the wheel, the cutting tools make multiple passes back and forth along the wheel profile, taking off material bit by bit until the wheel is even with the profile and the tools have no more material to take off. This truing apparatus of the present invention is more efficient because it uses multiple tool bits, each only responsible for cutting a portion of the wheel profile, instead of one cutting tool that cuts the entire profile of the wheel.

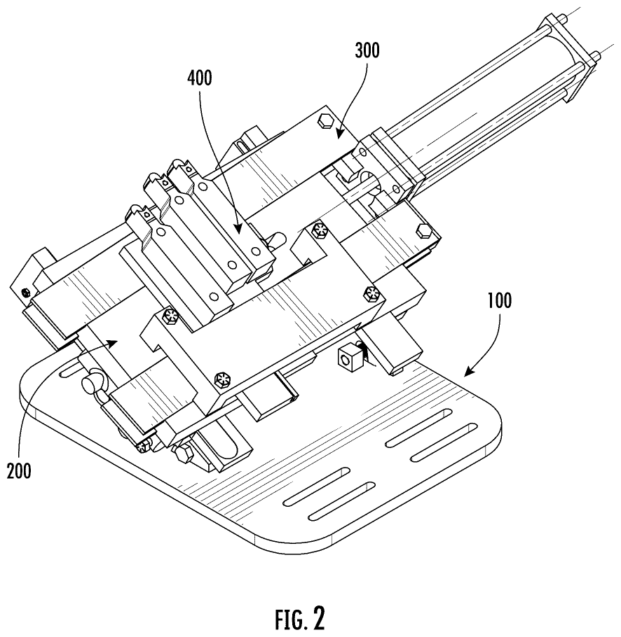

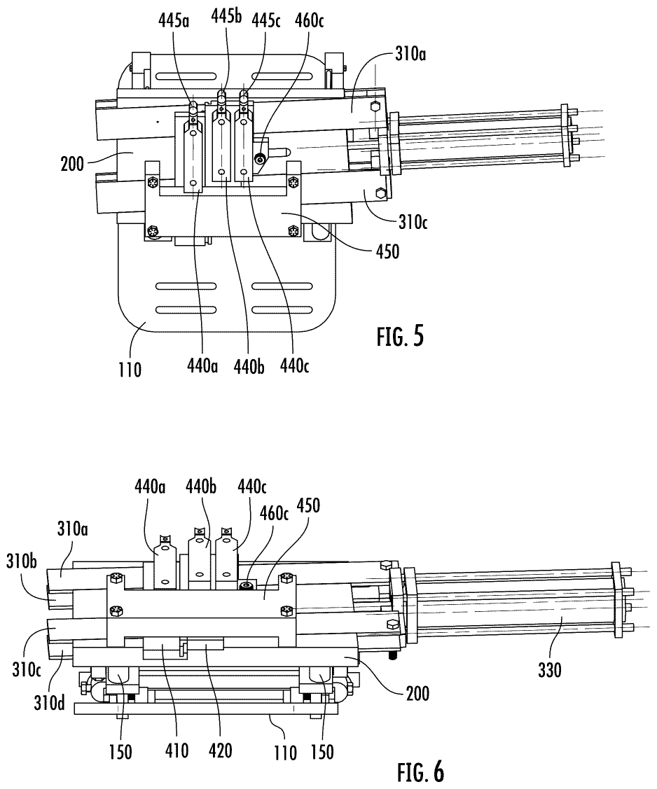

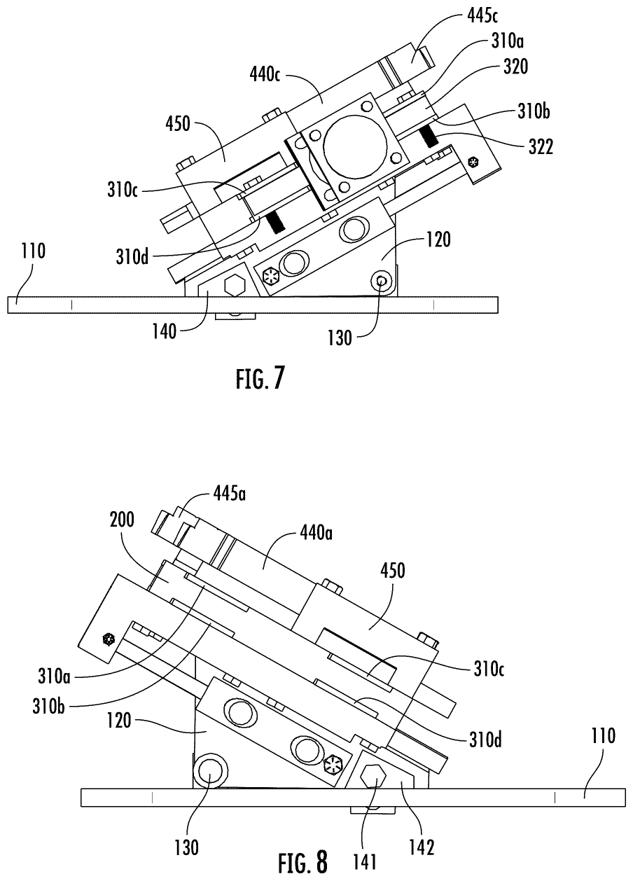

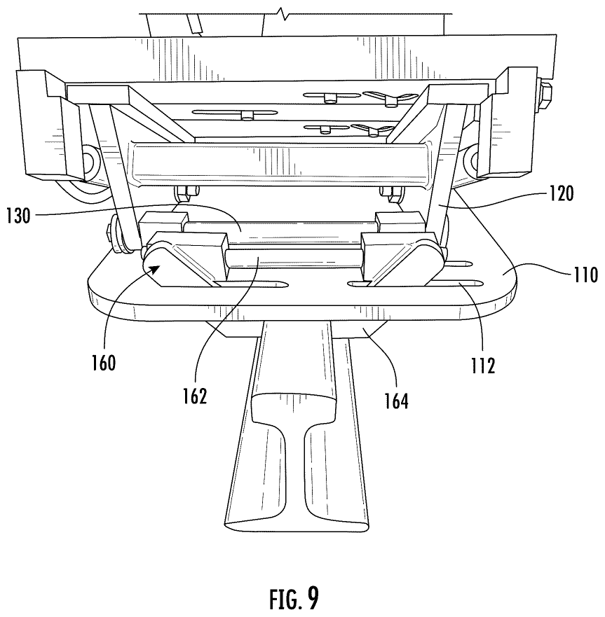

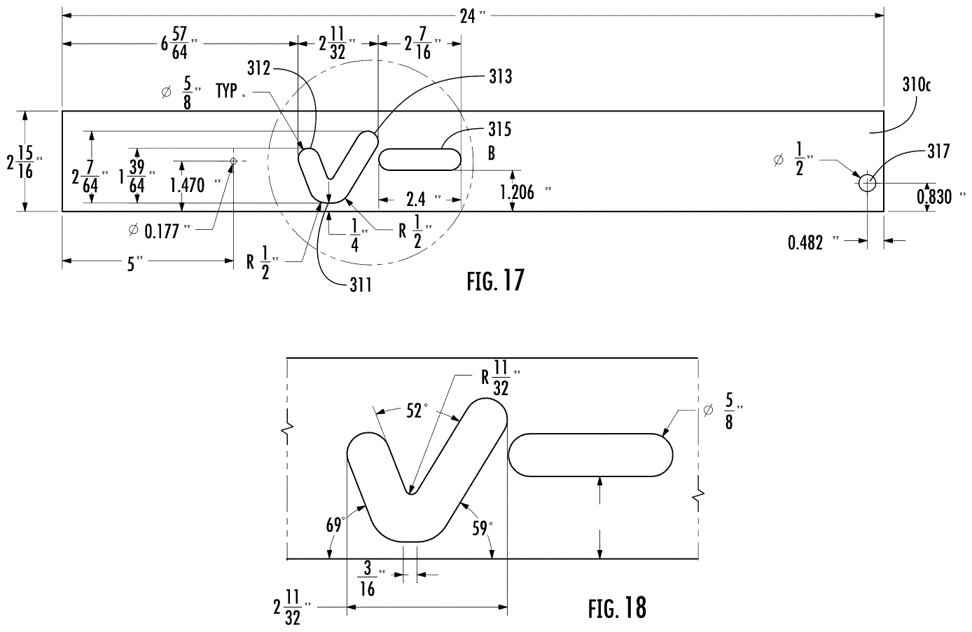

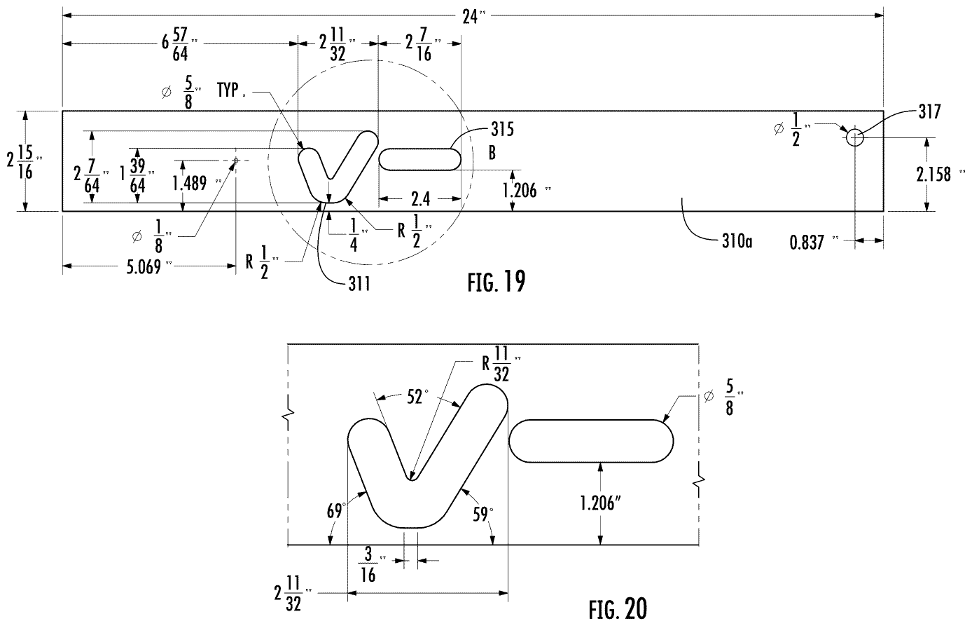

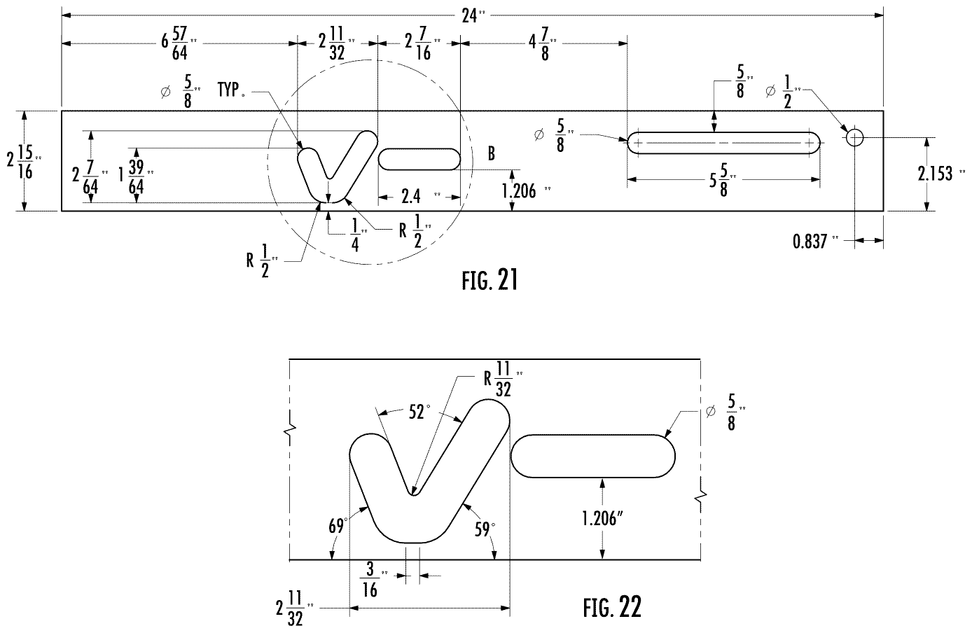

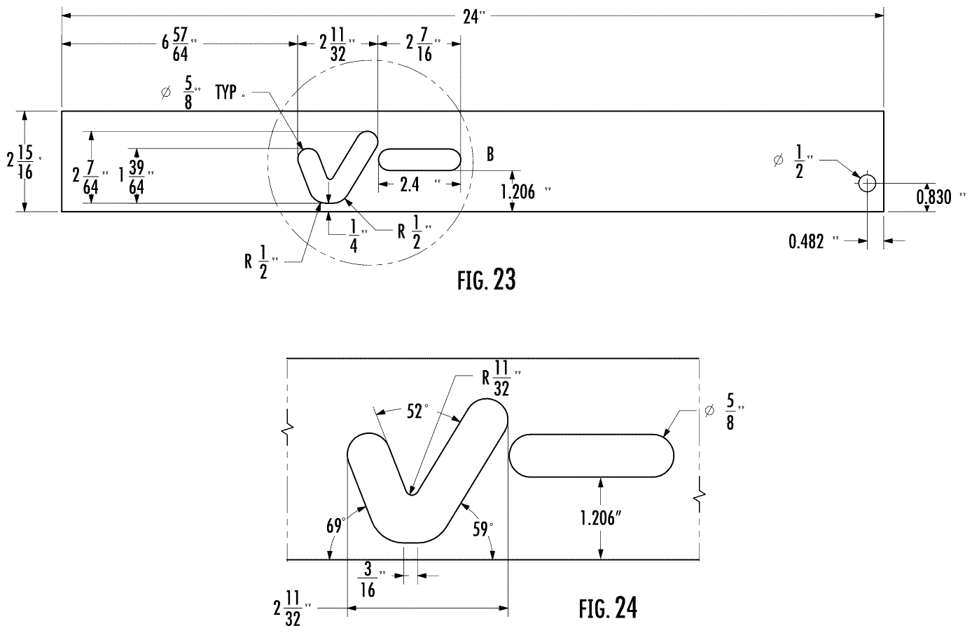

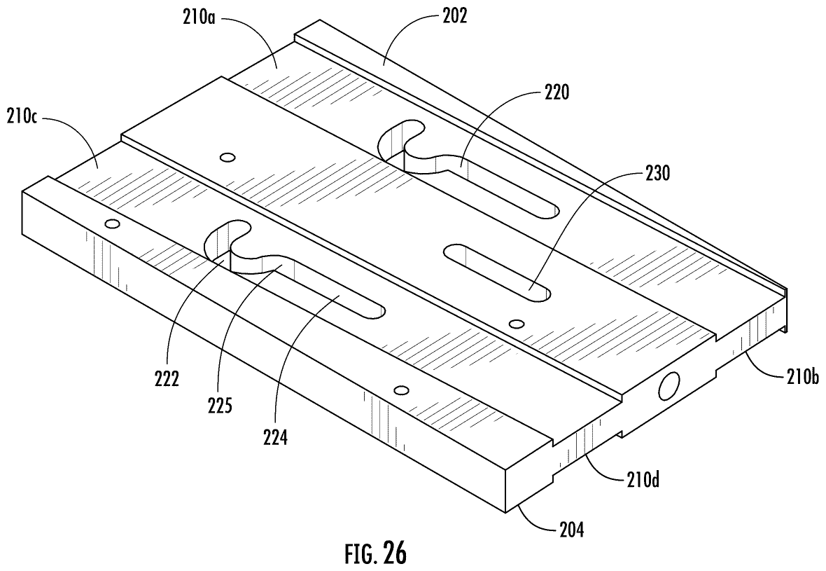

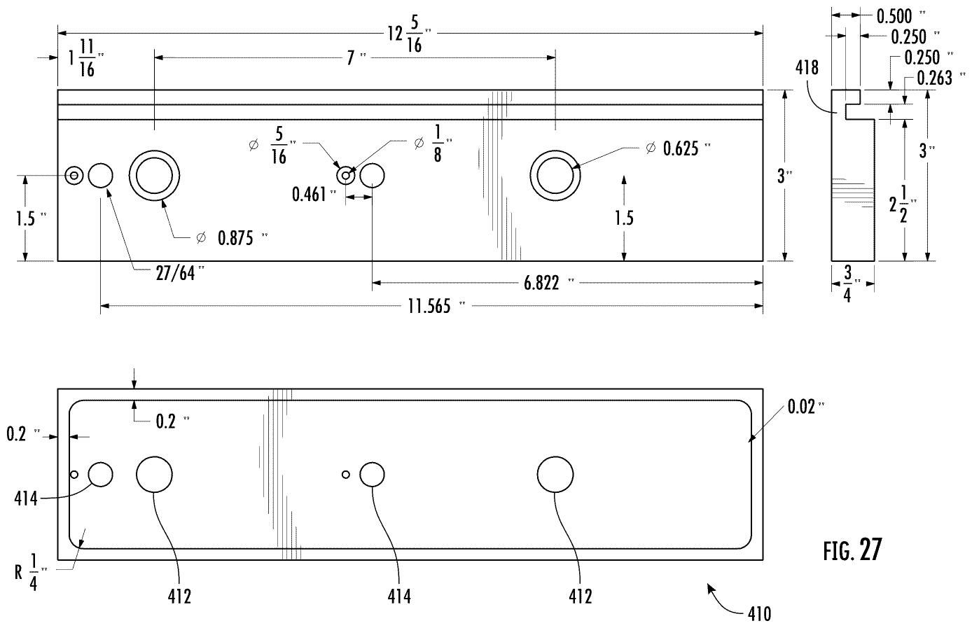

An embodiment of a portable railway wheel truing apparatus embodying the principles of the present invention is depicted in FIGS. 1-28. Viewing FIGS. 1-2, the railway truing apparatus 1 may comprise a base assembly 100, a guide plate 200, a drive plate assembly 300, and a tooling assembly 400. The base assembly 100 secures the apparatus 1 to the rail and supports the remaining components of the machine. The guide plate 200 and the drive plate assembly 300 work together to move the tooling assembly's tool holders 440a-c both axially (i.e., parallel to the axis of the wheel) and radially (i.e., toward and away from the wheel's surface) in a preset manner dictated by the geometry of slots formed in the guide plate 200 and drive plate assembly 300. In this arrangement, the apparatus 1 provides a means for simultaneously truing both the wheel's flange and tread while removing operator error.

### Base Assembly

Turning to FIGS. 3, 7-9, a preferred embodiment of a base assembly 100 is depicted. The base assembly 100 may comprise a base plate 110, two angular mount plates 120, a pivot bar assembly 130, two angle locks 140, and two mount brackets 150.

The base plate 110 comprises clamp slots 112 through which the clamps 160 extend to clamp the base assembly 100 to a rail. In this embodiment, the clamps 160 are vice clamps that comprise a clamp bar 162 that connects opposing clamp hooks 164. The clamp hooks 164 extend through the clamp slots 112 and are tightened from the top until they firmly rest against the rail, securing the base plate 110 to the top of the rail. In other embodiments, any other suitable system known in the art could be used to temporarily secure the machine to the rail. However, the clamp design of the present invention is beneficial as compared to industry standard clamps, which require one worker to stand underneath the locomotive and position the clamp from underneath the wheel truing machine while another worker tightens the clamp from above. Using the clamp system of the present invention, only one worker is needed to both slide the clamp hooks 164 through the clamp slots 112 and tighten the bolt(s) from the field side of the locomotive. Thus, the clamp system of the present invention is simpler, safer, and more efficient.

The angular mount plates 120 are triangular-shaped structures that function to provide an angled mounting platform for the guide plate 200. The angular mount plates 120 may be attached to left and right sides of the base plate 110 and are generally parallel to each other. In preferred embodiments, the angular mount plates 120 orient the guide plate 200 at an angle of 29 degrees, which can be adjusted ±7 degrees relative to the base plate 110 as described in greater detail herein. Left and right mount brackets 150 may be attached to the left and right angular mount plates 120, respectively, to provide a support surface for the guide plate 200.

The pivot bar assembly 130 and the left and right angle locks 140 function together to provide a means for adjusting the orientation of the left and right angular mount plates 120 relative to the base plate 110. The rear portion of the angular mount plates 120 are pivotally connected to the base plate 110 utilizing the pivot bar assembly 130. The pivot bar assembly 130 comprises a cylindrical bar 131 and rectangular pivot mounts 132. The rectangular pivot mounts are secured to the base plate 110. The cylindrical bar 131 extends through apertures in the angular mount plates 120 to provide a fulcrum about which the angular mount plates 120 may pivot. The pivot bar 130 acts as a vice clamp, squeezing the mount plates 120 together and providing tension to prevent the machine 1 from vibrating during operations.

The left and right angle locks 140 adjustably connect the front portion of the angular mount plates 120 to the base plate 110. The angle locks 140 are positioned approximate to the front vertex of each angular mount plate 120. The angle locks 140 may each comprise a tapered block 141 and a lock bolt 142. The tapered blocks 141 have a generally triangular, wedge-shaped cross-section. The lock bolt 142 extends through apertures in the tapered blocks 141 and the sidewalls of the angular mount plates 120. In this arrangement, the tapered blocks 141 can be rotated about the lock bolt 142 to adjust the spacing between the front of the angular mount plate 120 and the base plate 110, which in turn adjusts the overall angle of the guide plate 200 relative to the base plate 110. This adjustability is beneficial because, for optimal efficiency during operation, the cutting tools 445 should be angled just below the center of rotation of the wheel. In operation, to adjust the angle of the apparatus 1 during setup, the lock bolts 142 on the angle locks 140 may be loosened, the positioning of the tapered blocks 141 can be rotated about the lock bolts 142 in a rearward or forward direction to raise or lower the front portion of the angular mount plates 120, and then the lock bolts 142 can be retightened once the tooling assembly 400 is positioned at the desired height and angle relative to the wheel.

### Guide Plate

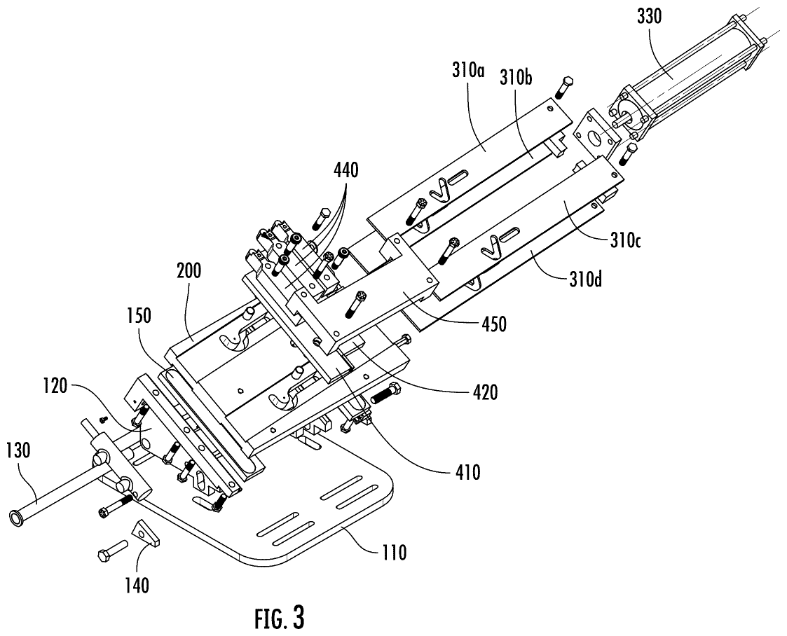

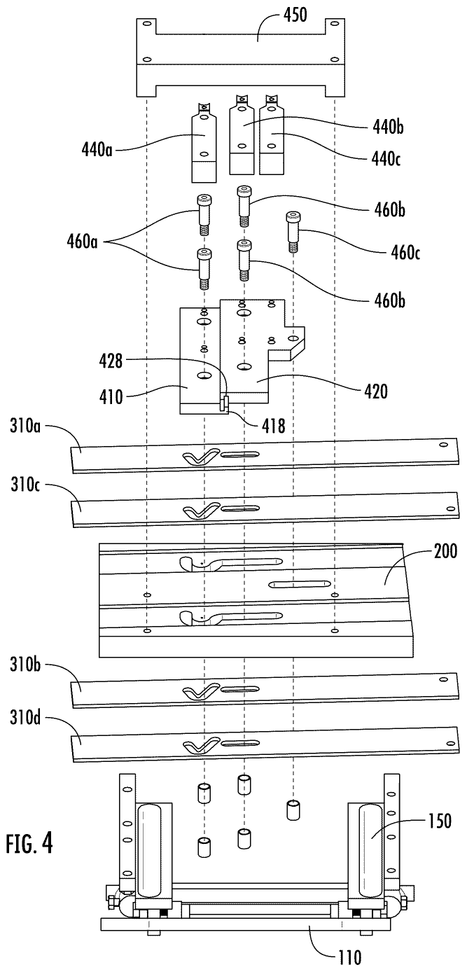

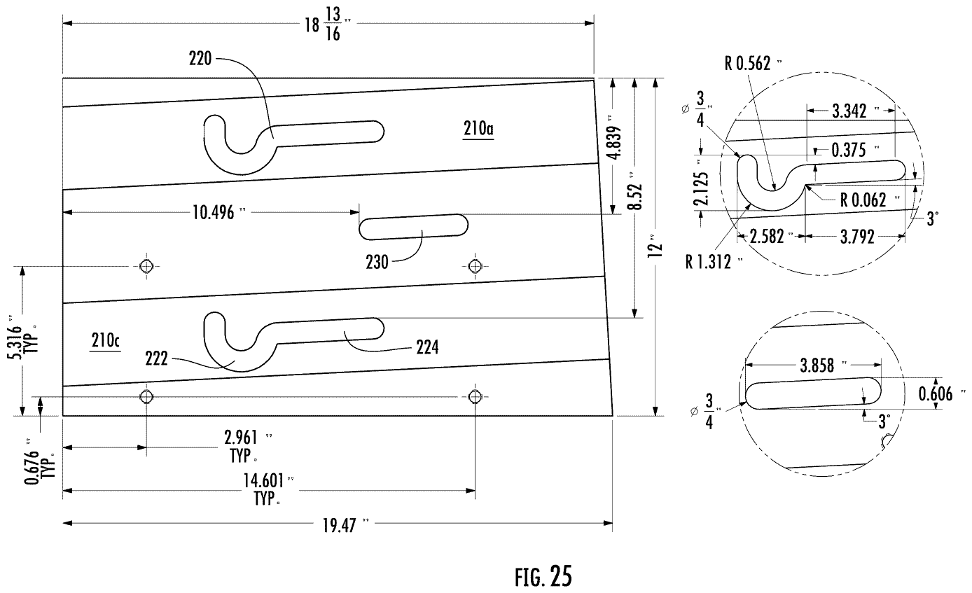

Viewing FIGS. 4, 25-26, the guide plate 200 is fixedly attached to the left and right mount brackets 150 of the base assembly 100 with fasteners or other means known in the art. The guide plate 200 comprises an upper face 202 and a lower face 204. The upper face 202 has first and second upper guide channels 210a, 210c formed therein, while the lower face 204 has corresponding first and second lower guide channels 210b, 210d formed therein. Specifically, the position of the first guide channel 210a on the upper face 202 runs parallel with the position of the third guide channel 210c on the lower face, while the position of the second guide channel 210b on the upper face 202 runs parallel with the position of the fourth guide channel 210d on the lower face. The upper and lower guide channels 210a-d are adapted to receive the drive plates 310a-d, respectively, as discussed in further detail herein, and therefore each guide channel 210 has a width only incrementally larger than the width of the drive plates 310. In a preferred embodiment the guide channels 210 will be oriented and have the dimensions as shown in FIG. 25. The guide channels 210 are offset from the front and rear ends of the guide plate 200 by an angle of 3 degrees.

Still referring to FIGS. 4, 25-26, the guide plate 200 further comprises guide slots 220, 225, 230. The first guide slot 220 is formed within the first guide channels 210a, 210b, while the second guide slot 225 is formed within the second guide channels 210c, 210d. Each of the first and second guide slots 220, 225 comprise a semi-circular portion 222 connected to a linear portion 224. As best shown in FIG. 3, the semi-circular portion 222 is oriented towards the left end of the guide plate 200, while the linear portion 224 is oriented towards the right end of the guide plate 200. The first and second guide slots 220, 225 extend through the entire thickness of the guide plate 200. Meanwhile, the third guide slot 230 is formed in the guide plate 200 between the upper and lower guide channels 210a-d. The third guide slot 230 is a substantially linear slot. In a preferred embodiment, the first, second and third guide slots will be oriented and have the dimensions as shown in FIG. 25.

### Drive Assembly

Turning to FIGS. 3-4 and 17-24, the drive assembly 300 may comprise four drive plates 310 and a hydraulic cylinder 330 powering their movement. The drive plates 310 comprise thin, rectangular sheets that fit into and slide freely through the guide channels 210 on the guide plate 200. The first, second, third, and fourth drive plates 310a, b, c, d correspond to the first, second, third, and fourth guide channels 210a, b, c, d respectively. Best viewed in FIG. 7, separation blocks 320 are attached between the ends of the first and third guide plates 310a, 310c and the ends of the second and fourth guide plates 310b, 310d to prevent the plates from wobbling during operation. Each drive plate 310 comprises first and second drive slots 311, 315. The first drive slot 311 is generally v-shaped, comprising a first arm 312 and a second arm 313, with the second arm 313 being longer than the first arm 312. The second drive slot 315 is a substantially linear slot. In a preferred embodiment, the first and second drive slots will be oriented and have the dimensions as shown in FIGS. 18-24. The drive plates 310 are powered by a hydraulic cylinder 330 in the embodiment depicted in the Figures, but in other embodiments, the drive plates 310 may be powered pneumatically, electrically, or by any other suitable method known in the art.

### Tooling Assembly

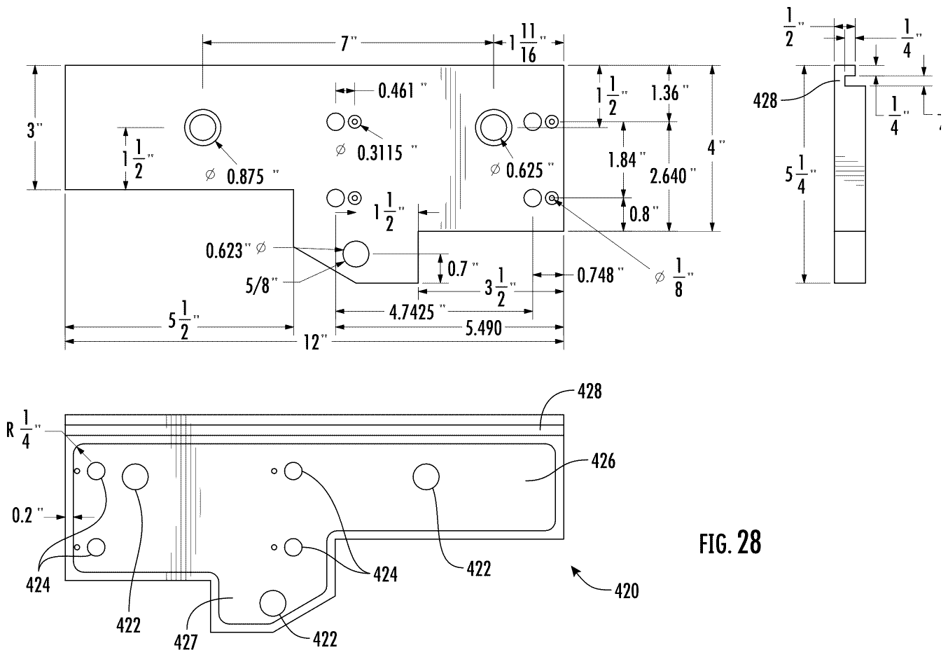

Turning to FIGS. 3-4 and 27-28, the tooling assembly 400 may comprise first and second tool holder plates 410, 420, tool holders 440a-c disposed on the tool holder plates, tool bits 445a-c attached to the respective tool holder 440a-c, a cover 450, and guide pins 460. The tool holder plates 410, 420 comprise guide pin holes 412, 422 adapted to receive the guide pins 460, and threaded boreholes 414, 424 adapted to receive bolts to connect the tool holders 440 to the tool holder plates 410, 420. The first tool holder plate 410, shown in FIG. 27, is rectangular in shape and comprises two guide pin holes 412 for the first tool holder 440a. The second tool holder plate 420, shown in FIG. 28, comprises a primary rectangular portion 426 and then a smaller protruding portion 427. The primary rectangular portion 426 comprises two guide pin holes 422 for the second tool holder 440b, and the smaller protruding portion 427 comprises one guide pin hole 422 for the third tool holder 440c. The tool holder plates 410, 420 comprise corresponding, interlocking lips 418, 428 so that they are held together while the first tool holder plate 410 maintains the ability to slide independently of the second tool holder plate 420 in the radial direction. In the exemplary embodiment depicted in the Figures, the cutting tool bit 445 is an RNMG64 tool bit, but in other embodiments, any suitable tool for cutting or truing a railway wheel may be used.

FIGS. 3-4 illustrate how the base assembly 100, guide plate 200, drive plate assembly 300, and tooling assembly 400 interact with one another. Guide plate 200 is secured to the mount brackets 150 of the base assembly 100. Then, drive plates 310 slide into the guide channels 210. Then, guide pins 460 pass through the guide pin holes 412, 422 in the tool holder plates 410, 420, through drive slots 311, 315 in the drive plates 310, and finally through guide slots 220, 225, 230 in the guide plate 200. As the drive plates 310 slide back and forth across the guide plate 200, they force the guide pins 460 to move within the slots, which in turn moves the tooling assembly 400 along the wheel profile. Due to the overlap of the drive slots 311, 315 in the drive plates 310 with the guide slots 220, 225 on the guide plate 200, the movement of the guide pins 460a for the first tool holder 440a is confined to the semi-circular portion 222 of the first and second guide slots 220, 225, and the movement of the guide pins 460b for the second tool holder 440b is confined to the linear portion 224 of the first and second guide slots 220, 225.

The particular arrangement of the guide pins 460 within the various slots of the drive plates 310 and guide plate 200 are as follows. When the apparatus 1 is assembled, the guide pins 460a, 460b for the first and second tool holders 440a, 440b are positioned in the first and second guide slots 220, 225 and the guide pin 460c for the third tool holder 440c is positioned in the third guide slot 230. One guide pin 460a for the first tool holder 440a passes through a guide pin hole 412 in the first tool holder plate 410, through the first drive slot 311a in the first drive plate 310a, through the semi-circular portion 222 of the first second guide slot 220 that extends through the first and third guide channels 210a, 210c, and then through the first drive slot 311c in the third drive plate 310c. The other guide pin 460a for the first tool holder 440a passes through the other guide pin hole 412 in the first tool holder plate 410, through the first drive slot 311b in the second drive plate 310b, through the semi-circular portion 222 of the second guide slot 225 that extends through the second and fourth guide channels 210b, 210d, and then through the first drive slot 311d in the fourth drive plate 310d.

One guide pin 460b for the second tool holder 440b passes through a guide pin hole 422 in the primary rectangular portion 426 of the second tool holder plate 420, through the second drive slot 315a of the first drive plate 310a, through the linear portion 224 of the first guide slot 220 that extends through the first and third guide channels 210a, 210c, then through the second drive slot 315c of the third drive plate 310c. The other guide pin 460b for the second tool holder 440b passes through the other guide pin hole 422 in the primary rectangular portion 426 of the second tool holder plate 420, through the second drive slot 315b of the second drive plate 310b, through the linear portion 224 of the second guide slot 225 that extends through the second and fourth guide channels 210b, 210d, then through the second drive slot 315d of the third drive plate 310d. The guide pin 460c for the third tool holder 440c passes through the guide pin hole 422 in the smaller protruding portion 427 of the second tool holder plate 420 and then through the third guide slot 230 of the guide plate 200. There is no overlap of the drive plates 310 with the third guide slot 230 of the guide plate 200, so the guide pin 460c does not interact with the drive plates 310 at all. Because the guide pin 460c runs through the second tool holder plate 420, the force the drive plates 310 impart on the guide pins 460b for the second tool holder 440b is sufficient to move the guide pin 460c for the third tool holder 440c within the third guide slot 230.

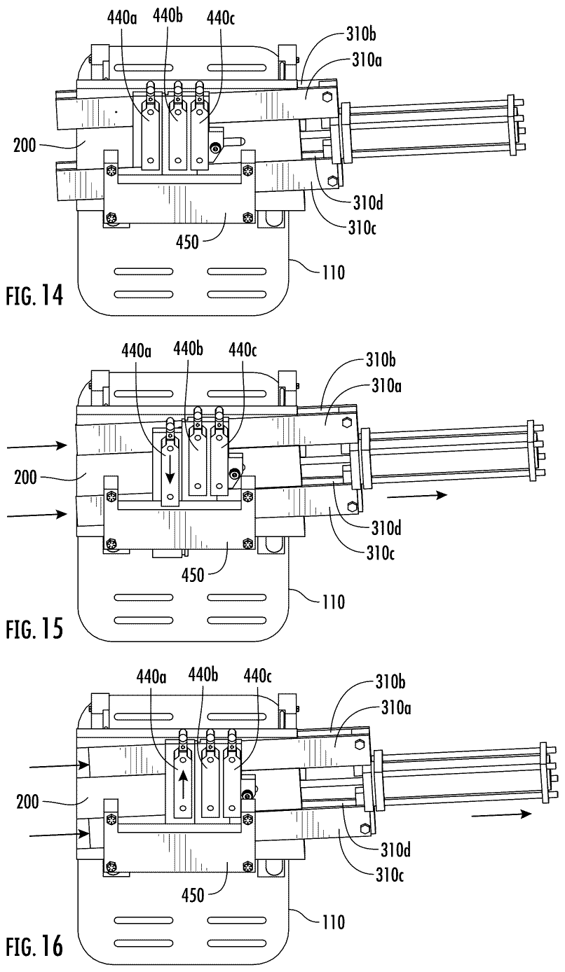

FIGS. 14-16 illustrate the movement of the tools along the wheel profile. As can be seen in FIG. 14, at their leftmost position, hereinafter referred to as the First Position, the first tool bit 445a is roughly even with the second and third tool bits 445b, 445c in the radial direction. In practice, at this point the first tool bit 445a would be on the outside of the flange of the wheel. Then, as the tools move to the right as shown in FIG. 15, hereinafter referred to as the Second Position, the first tool holder 440a moves away from the wheel relative to the other tool holders 440b, 440c so that it can cut around the shape of the flange. Then, as the tools continue to the right as in FIG. 16, hereinafter referred to as the Third Position, the first tool holder 440a moves back towards the wheel relative to the other tool holders 440b, 440c, cutting down the inner side of the flange of the wheel, also known as the throat. The whole time, the second and third tool holders 440b, 440c are cutting the same linear path along the wheel tread.

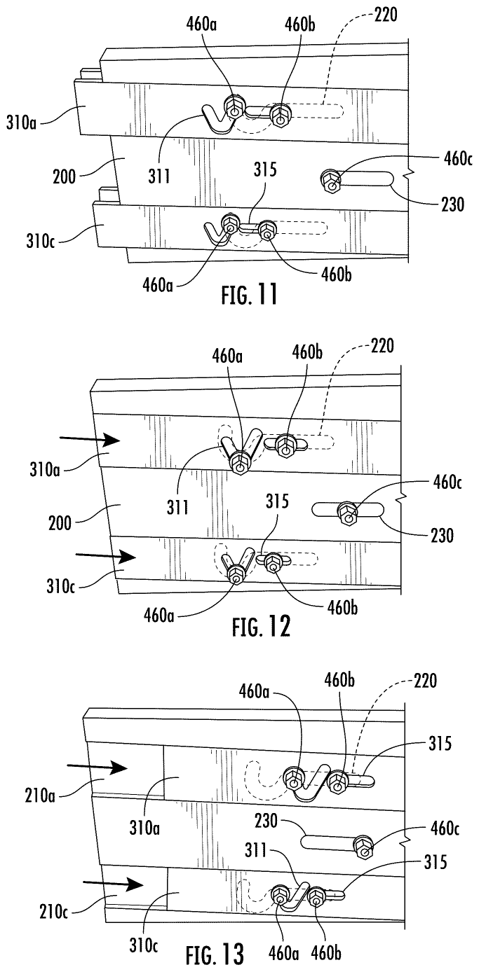

FIGS. 11-13 illustrate the movement of the guide pins 460 beneath the tools. In the First Position (FIGS. 11, 14), the first guide pins 460a are at the top of the second arm 313 of the first drive slot 311 and at the top of the left side of the semi-circular portion 222 of the first and second guide slots 220, 225. At the same time, the second guide pins 460b are positioned at the right side of the second drive slot 315 and on the far-left side of the linear portion 224 of the first and second guide slots 220, 225, and the third guide pin 460c is at the far-left side of the third guide slot 230. In the Second Position (FIGS. 12, 15), the first guide pins 460a are at the vertex of the first drive slot 311 and at the bottom of the semi-circular portion 222 of the first and second guide slots 220, 225. The second guide pins 460b are at the middle of the second drive slot 315 and the middle of the linear portion 224 of the first and second guide slots 220, 225, and the third guide pin 460c is at the middle of the third guide slot 230. In the Third Position (FIGS. 13, 16), the first guide pins 460a are at the top of the first arm 312 of the first drive slot 311 and the top of the right side of the semi-circular portion 222 of the first and second guide slots 220, 225. At the same time, the second guide pins 460b are at the leftmost side of the second drive slot 315 and the rightmost side of the linear portion 224 of the first and second guide slots 220, 225, and the third guide pin 460c is at the right most portion of the third guide slot 230. Thus, each cutting tool 445 is only responsible for truing one third of the wheel profile, making it more efficient than traditional portable railway wheel truing machines which use one cutting tool for the entire wheel profile.

Many modifications and other embodiments of the invention set forth herein will come to mind to one skilled in the art having the benefit of the teaching presented in the foregoing description and associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A portable railway wheel truing apparatus, comprising:
a) a base assembly;
b) a guide plate secured to the base assembly, wherein the guide plate comprises guide channels and guide slots;
c) one or more drive plates operatively coupled to the guide channels, wherein each drive plate comprises at least two drive slots;
d) two or more cutting tools, wherein each cutting tool is operatively coupled to at least one of (i) one of the drive slots and (ii) one of the guide slots; and wherein relative movement between the one or more drive plates and the guide plate controls reciprocating movement of the two or more cutting tools.

2. The portable railway wheel truing apparatus of claim 1, wherein the base assembly comprises a base plate and angular mount plates pivotally attached to the base plate by a pivot bar; wherein the guide plate is secured to the angular mount plates; and wherein an angle of the guide plate relative to the base plate is adjustable by pivoting the angular mount plates around the pivot bar.

3. The portable railway wheel truing apparatus of claim 1, wherein the base assembly comprises a base plate and a vice clamp, wherein the vice clamp comprises opposing clamp hooks that are configured to pass through slots in the base plate and contact either side of a rail to secure the portable railway wheel truing apparatus to the rail.

4. The portable railway wheel truing apparatus of claim 3, wherein the guide plate comprises an upper face and a lower face; wherein the guide channels comprise (i) a first upper guide channel positioned on the upper face, (ii) a second upper guide channel positioned on the upper face, (iii) a first lower guide channel positioned on the lower face, (iv) and a second lower guide channel positioned on the lower face.

5. The portable railway wheel truing apparatus of claim 4, wherein the guide slots of the guide plate comprise:
a) a first guide slot formed through the first upper guide channel and the first lower guide channel, the first guide slot comprising a curved section having a generally semicircular profile and a linear section extending from one end of the curved section, the curved section and linear section being integrally formed and having a substantially uniform cross-sectional thickness;
b) a second guide slot formed through the second upper guide channel and the second lower guide channel, the second guide slot comprising a curved section having a generally semicircular profile and a linear section extending from one end of the curved section, the curved section and linear section being integrally formed and having a substantially uniform cross-sectional thickness; and
c) a third guide slot formed through the upper face and the lower face of the guide plate in between the first guide channels and the second guide channels, the third guide slot comprising a linear profile and having a substantially uniform cross-sectional thickness.

6. The portable railway wheel truing apparatus of claim 5, wherein the one or more drive plates comprise a first upper drive plate, a second upper drive plate, a first lower drive plate, and a second lower drive plate, wherein the first upper drive plate is slidably received within the first upper guide channel, the second upper drive plate is slidably received within the second upper guide channel, the first lower drive plate is slidably received within the first lower guide channel, and the second lower drive plate is slidably received within the second lower guide channel.

7. The portable railway wheel truing apparatus of claim 6, wherein the drive slots of the drive plates comprise:
a) a first drive slot comprising a generally v-shaped profile with a first arm and a second arm that is longer than the first arm, the first drive slot having a substantially uniform cross-sectional thickness; and
b) a second drive slot comprising a linear profile and having a substantially uniform cross-sectional thickness.

8. The portable railway wheel truing apparatus of claim 7, wherein the cutting tools comprise a first cutting tool, a second cutting tool, and a third cutting tool, and wherein:
a) a first guide pin attached to the first cutting tool is positioned within the curved sections of the first and second guide slots and with the first drive slots;
b) a second guide pin attached to the second cutting tool is positioned within the linear sections of the first and second guide slots and with the second drive slots; and
c) a third guide pin attached to the third cutting tool is positioned within the third guide slot.

9. A portable railway wheel truing apparatus, comprising:
a) a base assembly;
b) a guide assembly comprising a plurality of guide slots, each guide slot configured
to receive a corresponding guide pin, the plurality of guide slots defining a path for movement of the guide pins according to a preset wheel profile; and
c) a plurality of cutting tools, each cutting tool being operatively coupled to at least one guide pin.

10. The portable railway wheel truing apparatus of claim 9, wherein the guide assembly comprises a guide plate secured to the base assembly, wherein the plurality of guide slots are formed in the guide plate.

11. The portable railway wheel truing apparatus of claim 10, wherein the plurality of guide slots comprises:
a) a first guide slot comprising a curved section having a generally semicircular profile and a linear section extending from one end of the curved section, the curved section and linear section being integrally formed and having a substantially uniform cross-sectional thickness;
b) a second guide slot comprising a curved section having a generally semicircular profile and a linear section extending from one end of the curved section, the curved section and linear section being integrally formed and having a substantially uniform cross-sectional thickness; and
c) a third guide slot comprising a linear profile and having a substantially uniform cross-sectional thickness.

12. The portable railway wheel truing apparatus of claim 11, further comprising a plurality of drive plates, each comprising:
a) a first drive slot comprising a generally v-shaped profile with a first arm and a second arm that is longer than the first arm, the first drive slot having a substantially uniform cross-sectional thickness; and
b) a second drive slot comprising a linear profile and having a substantially uniform cross-sectional thickness.

13. The portable railway wheel truing apparatus of claim 12, wherein the drive slots of the drive plates overlap with the guide slots of the guide plate to create the path for movement of the guide pins.

14. The portable railway wheel truing apparatus of claim 13, wherein the plurality of cutting tools comprises a first cutting tool, a second cutting tool, and a third cutting tool, and wherein:
a) the guide pins attached to the first cutting tool engage with the curved sections of the first and second guide slots and with the first drive slots;
b) the guide pins attached to the second cutting tool engage with the linear sections of the first and second guide slots and with the second drive slots; and
c) the guide pins attached to the third cutting tool engage with the third guide slot.

15. The portable railway wheel truing apparatus of claim 14, further comprising:
a) a first tool holder plate positioned between the first cutting tool and its corresponding guide pins; and
b) a second tool holder plate positioned between the second and third cutting tools and their corresponding guide pins.

16. The portable railway wheel truing apparatus of claim 9, wherein the base assembly comprises a base plate and angular mount plates pivotally attached to the base plate by a pivot bar; wherein the guide plate is secured to the angular mount plates; and wherein an angle of the guide plate relative to the base plate is adjustable by pivoting the angular mount plates around the pivot bar.

17. The portable railway wheel truing apparatus of claim 9, wherein the base assembly comprises a base plate and a vice clamp, wherein the vice clamp comprises opposing clamp hooks that are configured to pass through slots in the base plate and contact either side of a rail to secure the portable railway wheel truing apparatus to the rail.

18. A portable railway wheel truing apparatus, comprising:
a) a base assembly comprising a base plate and a vice clamp, wherein the vice clamp comprises opposing clamp hooks that are positioned to pass through slots in the base plate to secure the base plate to a rail;
b) a guide plate secured to the base assembly, wherein the guide plate comprises guide channels and guide slots;
c) one or more drive plates operatively coupled to the guide channels, wherein each drive plate comprises at least two drive slots;
d) one or more cutting tools, wherein each cutting tool is operatively coupled to at least one of (i) one of the drive slots and (ii) one of the guide slots; and wherein relative movement between the one or more drive plates and the guide plate controls reciprocating movement of the two or more cutting tools.

19. The portable railway wheel truing apparatus of claim 18, wherein the at least one cutting tool comprises a first cutting tool, a second cutting tool, and a third cutting tool.
